(19) United States
(12) Patent Application Publication
(10) Pub. No.: US 2023/0027476 A1
(43) Pub. Date: Jan. 26, 2023

(54) ADAPTIVE CELL-SHAPING IN A CELLULAR NETWORK

(71) Applicant: Telefonaktiebolaget LM Ericsson (publ), Stockholm (SE)

(72) Inventors: Jingya LI, Göteborg (SE); Andreas NILSSON, Göteborg (SE); Joakim AKESSON, Landvetter (SE); Daniel GULDBRAND, Ödsmål (SE); Sven PETERSON, Sävedalen (SE); Xinlin ZHANG, Göteborg (SE); Fredrik ATHLEY, Kullavik (SE)

(73) Assignee: Telefonaktiebolaget LM Ericsson (publ), Stockholm (SE)

(21) Appl. No.: 17/786,521

(22) PCT Filed: Dec. 18, 2019
(86) PCT No.: PCT/EP2019/085977

§ 371 Date: Jun. 16, 2022

(51) Int. Cl. H04W 16/28; H04W 24/02; H04W 24/08

(52) U.S. Cl. CPC H04W 16/28; H04W 24/02; H04W 24/08

(57) ABSTRACT

There is provided mechanisms for adaptive cell-shaping in a cellular network in which a group of radio access network nodes provide network access. A method is performed by a network node. The method comprises obtaining an indication of combined network performance degradation in a region in which a first radio access network node in the group of radio access network nodes provides network access and increased need for network access for prioritized service and/or prioritized subscribers in this region. The method comprises initiating adjustment of cell-degradation shaping parameters of at least one radio access network node in the group of radio access network nodes. Network access for the prioritized service and/or prioritized subscribers in the region is maintained by this at least one radio access network node in the group of radio access network nodes.

### TECHNICAL FIELD

Embodiments presented herein relate to a method, a network node, a computer program, and a computer program product for adaptive cell-shaping in a cellular network in which a group of radio access network nodes provide network access.

### BACKGROUND

In communications networks, such as cellular networks, there may be a challenge to obtain good performance and capacity for a given communications protocol, its parameters and the physical environment in which the communications network is deployed.

For example, one parameter in providing good performance and capacity for a given communications protocol in a cellular network is the ability to handle mission critical (MC) communication services, such as communication services relating to public safety.

The quality of service (QoS) requirements for MC communication services, e.g., MC push-to-talk (MCPTT), MCData and MCvideo are strict. A cellular network supporting MC communication services needs to provide high availability, high reliability, high priority, and low latency for MC communication services in both in-coverage and out-of-coverage operation modes. In addition, it should support efficient one-to-one and one-to-many types of communications, and priority and pre-emption functionalities to ensure traffic flows of the MC communication services are not impacted when the cellular network is overloaded.

The frequency spectrum used for MC communication services can either be a dedicated portion in the frequency spectrum as authorized by a government body, and/or be part of the frequency spectrum utilized for commercial use.

One aspect of public safety communications concerns communication within a public safety authority or between different public safety authorities. The term authorities here refers to emergency first responders (fire-fighters, police, paramedics etc.), emergency control centres, public safety answering points (PSAP), local administration or any other organization with the responsibility of providing services that ensure safety and security of citizens who are under risk or affected by an emergency event.

Another aspect of public safety communications concerns communication from citizens to authorities, commonly initiated by citizens as emergency calls to PSAPs.

Yet another aspect of public safety communications concerns communication from authorities to citizens, commonly implemented as public warning or emergency alerting services.

Yet another aspect of public safety communications concerns communication between citizens during emergencies, enabling victims and relatives or friends to stay in contact during or after an emergency.

In certain public safety scenarios, one or a few base stations of the cellular network might not be fully functioning to be able to support MC service communications. This can be due to either coverage issues and/or network congestion issues.

In case existing network infrastructure, such as one or more base station, was incapacitated, or otherwise has its function impaired or is left without power supply, potential network coverage gaps might occur in one or more geographical regions affected by the public safety scenario due to no, or very limited, network infrastructure availability. In other public safety scenarios, the network infrastructures might still be available and fully functional, but there can be service congestion caused by significantly increased network demand (e.g., large number of emergency calls being made) such that the throughput of the MC traffic is reduced. IOPS (Isolated E-UTRAN Operation for Public Safety, where E-UTRAN is short for Evolved Universal Terrestrial Radio Access Network) ensures network access for local MC communication services between public safety users via isolated base stations when the backhaul connectivity to the core network is not fully functional. The IOPS operation mode is usually used in public safety scenarios when the existing network infrastructure is damaged or completely destroyed, and in out of network coverage scenarios. IOPS-capable base stations are co-located with, or have connectivity to, a local core network, which can provide the basic functionalities of a traditional core network. In case the network infrastructure remains undamaged, but the backhaul connectivity is lost or damaged, IOPS-enabled base stations can switch from normal operation mode to IOPS mode. On the other hand, in case the existing infrastructure is destroyed, or initially unavailable, local communication can be provided through the ad-hoc deployment of portable, easily movable base stations (also referred to as nomadic eNBs/gNBs) on the spot, and these ad-hoc base stations can connect to the same local core network.

IOPS-enabled base stations need to be preselected during network planning. Hence, there is a chance that public safety scenarios occur where there are not nay deployed IOPS-enabled base stations. Further, there might be potential long interruption times (say, up to 300 seconds excluding core network aspects) when switching between normal operation and IOPS operation in an IOPS-enabled base station. For a network infrastructure without IOPS-enabled base stations, the time required for setting up an ad-hoc network can be relatively long and the deployment flexibility can be limited depending on the practical scenario. Also, integration with existing network infrastructure needs to be considered carefully when deploying the ad-hoc network.

This can either cause potential delays or limiting the deployment flexibility for providing public safety communications.

Although the above disclosure has been focused on MC services and subscribers to such services, the same issues apply also to other prioritized services and prioritized subscribers.

Hence, there is still a need for an improved handling of prioritized service and/or prioritized subscribers in situations of network performance degradation.

### SUMMARY

An object of embodiments herein is to provide efficient cell-shaping in a cellular network enabling improved handling of prioritized service and/or prioritized subscribers in situations of network performance degradation.

According to a first aspect there is presented a method for adaptive cell-shaping in a cellular network in which a group of radio access network nodes provide network access. The method is performed by a network node. The method comprises obtaining an indication of combined network performance degradation in a region in which a first radio access network node in the group of radio access network nodes provides network access and increased need for network access for prioritized service and/or prioritized subscribers in this region. The method comprises initiating adjustment of cell-shaping parameters of at least one radio access network node in the group of radio access network nodes. Network access for the prioritized service and/or prioritized subscribers in the region is maintained by this at least one radio access network node in the group of radio access network nodes.

According to a second aspect there is presented a network node for adaptive cell-shaping in a cellular network in which a group of radio access network nodes provide network access. The network node comprises processing circuitry. The processing circuitry is configured to cause the network node to obtain an indication of combined network performance degradation in a region in which a first radio access network node in the group of radio access network nodes provides network access and increased need for network access for prioritized service and/or prioritized subscribers in this region. The processing circuitry is configured to cause the network node to initiate adjustment of cell-shaping parameters of at least one radio access network node in the group of radio access network nodes. Network access for the prioritized service and/or prioritized subscribers in the region is maintained by this at least one radio access network node in the group of radio access network nodes.

According to a third aspect there is presented a network node for adaptive cell-shaping in a cellular network in which a group of radio access network nodes provide network access. The network node comprises an obtain module configured to obtain an indication of combined network performance degradation in a region in which a first radio access network node in the group of radio access network nodes provides network access and increased need for network access for prioritized service and/or prioritized subscribers in this region. The network node comprises an initiate module configured to initiate adjustment of cell-shaping parameters of at least one radio access network node in the group of radio access network nodes. Network access for the prioritized service and/or prioritized subscribers in the region is maintained by this at least one radio access network node in the group of radio access network nodes.

According to a fourth aspect there is presented a computer program for adaptive cell-shaping in a cellular network in which a group of radio access network nodes provide network access, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient cell-shaping in the cellular network.

Advantageously, the proposed cell-shaping enables improved handling of prioritized service and/or prioritized subscribers in situations of network performance degradation.

Advantageously, compared to the above disclosed IOPS-enabled base stations, these aspects do not require any pre-selection of radio access network nodes in the cellular network to be equipped with a local IOPS core. Instead, the existing network infrastructure can be utilized in a more adaptive and efficient way to ensure timely communications for prioritized service and/or prioritized subscribers.

Advantageously, these aspects do not require any human intervention.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 2, 4, 5, 6 are schematic diagrams illustrating a cellular network according to embodiments;

FIG. 3 is a flowchart of methods according to embodiments;

FIG. 7 is a schematic diagram showing functional units of a network node according to an embodiment;

FIG. 8 is a schematic diagram showing functional modules of a network node according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

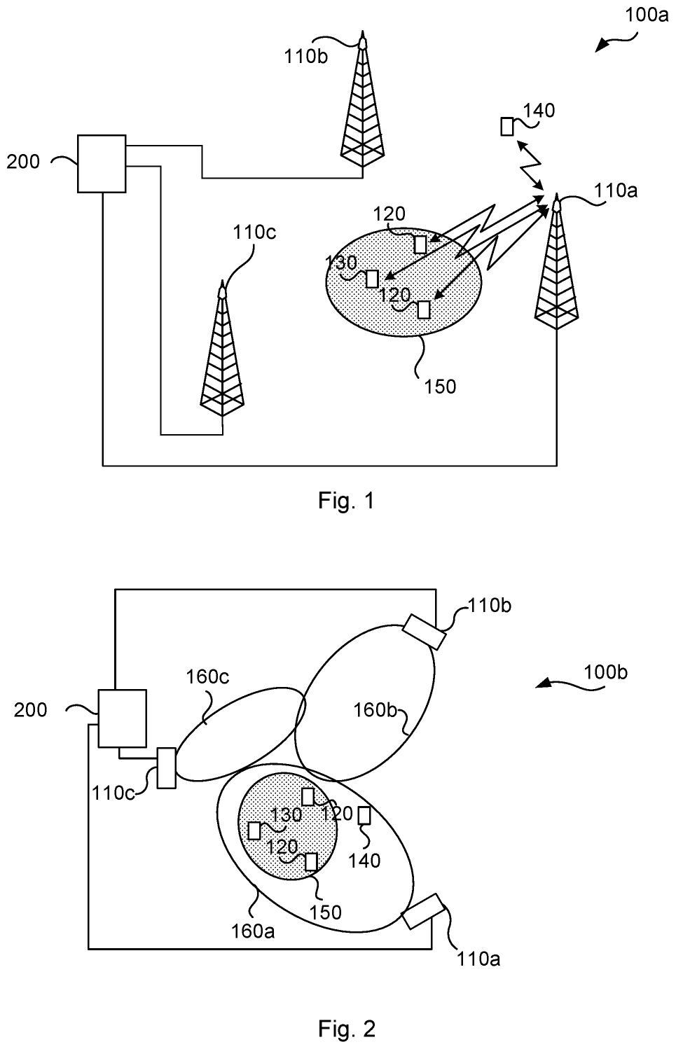

FIG. 1 is a schematic diagram illustrating a cellular network bow where embodiments presented herein can be applied. The cellular network bow comprises radio access network nodes 110a, 110b, 110c. Each of the radio access network nodes 110a, 110b, 110c might be a radio base station, base transceiver station, node B (NB), evolved node B (eNB), gNB, integrated access and backhaul (IAB) node, or access point. The radio access network nodes 110a:110c provide network access to terminal devices, where each terminal device could be any of a portable wireless device, mobile station, mobile phone, handset, wireless local loop phone, user equipment (UE), smartphone, laptop computer, or tablet computer. The terminal devices are hereinafter represented by subscribers 120, 130, 140. The radio access network nodes 110a:110c are operatively connected to a core network (not shown) which in turn is operatively connected to a service providing wide area network (not shown), such as the Internet. Further the radio access network nodes 110a:110c are operatively connected to a network node 200. Other terms for the network node 200 are network apparatus, network device, and network equipment. As will be further disclosed below, the network node 200 is configured to initiate adjustment of cell-shaping parameters to be applied at the radio access network nodes 110a, 110b, 110c.

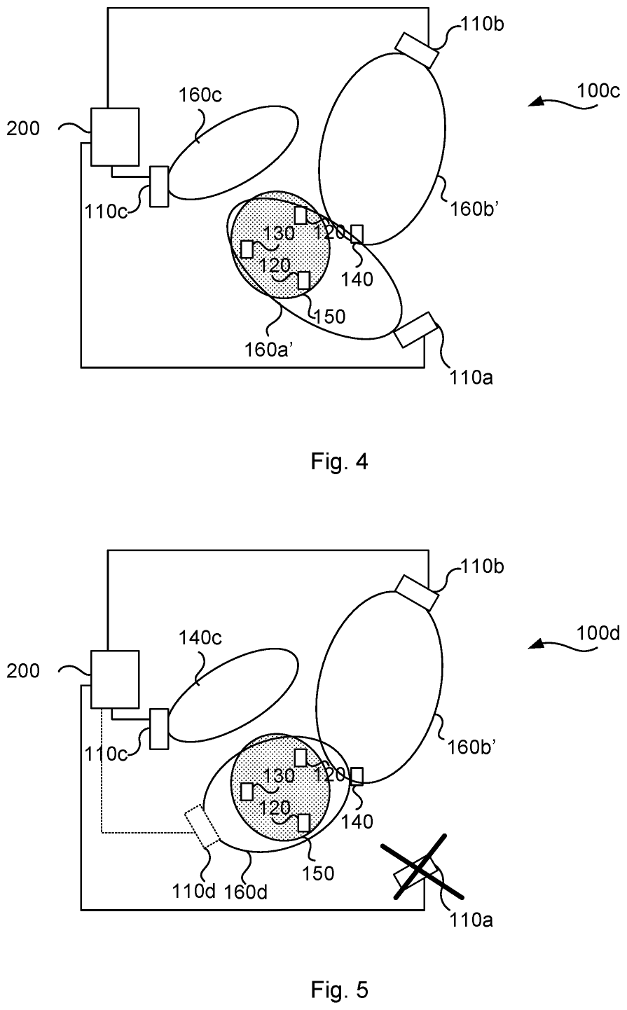

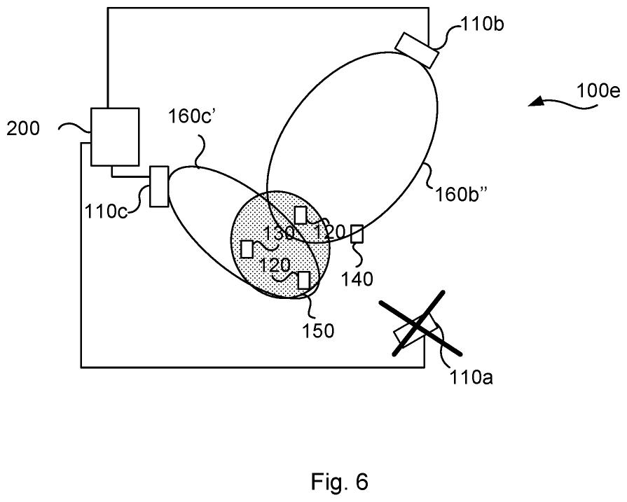

There could be different ways to provide, or implement the functionality of, the network node 200. In some examples the functionality of the network node 200 is, is part of, is integrated with, or is collocated with, a centralized network node, such as an Operations, Administration and Maintenance (OAM) node. In other aspects, the functionality of the network node 200 is, is part of, is integrated with, or is collocated with, at least one of the radio access network nodes 100a:100c and thus provided in a distributed fashion. Further aspects of the implementation of the network node 200 will be disclosed below with reference to FIGS. 7 and 8.

For illustrative purposes it is assumed that a region 150 is affected by network performance degradation. Region 150 will hereinafter therefore be referred to as an affected region. Subscribers 120, 130 are thus located within the affected region 150 whereas subscriber 140 is located outside the affected region 150.

Subscribers 120, of which there are two in the illustrative example of FIG. 1, are assumed to be subscribers of prioritized service and/or to be prioritized subscribers. Subscriber 130 and subscriber 140 are assumed to be normal non-prioritized subscribers and not subscribing to any prioritized service.

FIG. 2 illustrates a cellular network ioob similar to that of FIG. 1 but where also the coverage regions 160a, 160b, 160c of the radio access network nodes 110a, 110b, 110c are shown. In some examples, each coverage region 160a, 160b, 160c corresponds to the coverage of respective beam patterns utilized by the radio access network nodes 110a, 110b, 110c to provide network coverage within its coverage region 160a, 160b, 160c. As in FIG. 1, all subscribers 120, 130, 140 are served by radio access network node 110a. The shapes of the coverage regions 160a:160c are affected by the cell-shaping parameters. How the cell-shaping parameters can be adjusted will be disclosed below. According to the illustrative example of FIG. 2, the affected region 150 is part of the coverage region 160a of radio access network node 110a. Radio access network node 110a will hereinafter be referred to as a first radio access network node. However, this does not imply that there is any hierarchical relations between this radio access network node 110a and the other radio access network nodes 110b:110c.

As disclosed above there is need for an improved handling of prioritized service and/or prioritized subscribers 120 in situations of network performance degradation in the cellular network 100a, 100b.

At least some of the herein disclosed embodiments are therefore based on at least one of the radio access network nodes adjusting its cell shape parameters to ensure timely and reliable communications for prioritized service and/or prioritized subscribers 120 in the affected region 150 when there is a (potential) radio access network node failure and an increased demand (load) for prioritized service and/or prioritized subscribers 120 in the affected region 150.

The embodiments disclosed herein in particular relate to mechanisms for adaptive cell-shaping in a cellular network 100a:100e in which a group of radio access network nodes 110a:110d provide network access. In order to obtain such mechanisms there is provided a network node 200, a method performed by the network node 200, a computer program product comprising code, for example in the form of a computer program, that when run on a network node 200, causes the network node 200 to perform the method.

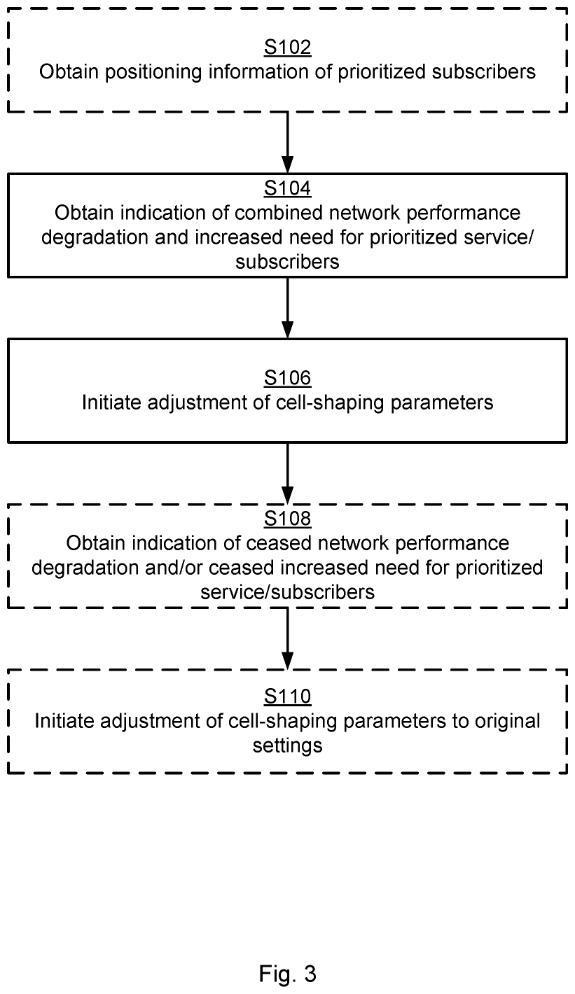

FIG. 3 is a flowchart illustrating embodiments of methods for adaptive cell-shaping in a cellular network bw: woe in which a group of radio access network nodes 110a:110d provide network access. The methods are performed by the network node 200. The methods are advantageously provided as computer programs 920.

The network node 200 is configured to detect or to be notified of (potential) network failures or degradation events in the cellular network bow, and to detect, or to be notified, of need for network access for prioritized service and/or prioritized subscribers 120. In particular, the network node 200 is configured to perform step S104:

S104: The network node 200 obtains an indication of combined network performance degradation in an affected region 150 in which a first radio access network node 110a in the group of radio access network nodes 110a:110d provides network access and increased need for network access for prioritized service and/or prioritized subscribers 120 in the affected region 150. That is, the network performance degradation in the affected region 150 occurs at the same time as there is an increased need for network access for prioritized service and/or prioritized subscribers 120 in the same affected region 150.

A cell-shape adaptation procedure is then triggered and at least one radio access network node 110a:110d is by the network node 200 instructed to adjust its cell-shaping parameters. In particular, the network node 200 is configured to perform step S106:

S106: The network node 200 initiates adjustment of cell-shaping parameters of at least one radio access network node 110a:110d in the group of radio access network nodes 110a:iiod. Network access for the prioritized service and/or prioritized subscribers 120 in the affected region 150 is maintained by this at least one radio access network node 110a:110d in the group of radio access network nodes 110a:110d.

This ensure timely and reliable communications for the prioritized service and/or prioritized subscribers 120 in the affected region 150 even though the affected region 150 at the same time is affected by network performance degradation.

Embodiments relating to further details of adaptive cell-shaping in a cellular network 100a:100e in which a group of radio access network nodes 110a:110d provide network access as performed by the network node 200 will now be disclosed.

There could be different types of prioritized service and/or prioritized subscribers 120. According to some embodiments, the prioritized service is an MC service, or a service as identified as prioritized by a network operator. According to some embodiments, the prioritized subscribers 120 are identified as prioritized by belonging to a prioritized access class, by having a prioritized service profile identifier (SPID) or are identified as prioritized by a network operator.

There could be different types of network performance degradations. In some examples, the indication of network performance degradation pertains to at least one of: decreased network performance in terms of key performance indicators (KPIs) monitored in the cellular network 110a:100e, network congestion experienced by the first radio access network node 100a, a loss of connection between the first radio access network node 110a and its core network, a loss of connection between a central unit (CU) in the first radio access network node 110a and a distributed unit (DU) in the first radio access network node 110a, a loss of connection between a CU in the first radio access network node 110a and a DU in another radio access network node in the group of radio access network nodes 110a:110d, handover statistics indicating that no handovers have been made to, or from, the first radio access network node ma during a first predefined time period, the number of radio link failure (RLF) reports issued during a second predefined time period being higher than a threshold number, output from a machine learning algorithm, and/or a message of a public warning or emergency alerting information.

In an example, a potential network performance degradation event is detected according to the KPIs that are used for network performance monitoring. For instance, one radio access network node might identify a potential network performance degradation event when observing a significantly increased amount of call drops and connection failures of another radio access network node, such as the first radio access network node 110a, no or very limited cell capacity, a coverage hole, a network congestion, or a cell outage.

In another example, the network node 200 is configured to monitor handover statistics between the radio access network nodes. In case no handover has been performed to/from a certain radio access network node, such as the first radio access network node 110a, for a certain period of time (optionally in combination with an increase of dropped calls from the same certain radio access network node), this might be an indication that the radio access network node is experiencing network performance degradation.

In another example, the network node 200 is configured to obtain information that a large amount of terminal devices 120, 130, 140 are sending RLF reports indicating that the RLF happened within a short period of time and where all these terminal devices 120, 130, 140 were operatively connected to one same certain radio access network node, such as the first radio access network node 110a. This might be an indication that the radio access network node is experiencing network performance degradation.

In another example, the network node 200 is configured to obtain information of a loss of connection between a certain radio access network node, such as the first radio access network node 110a, and the core network, e.g., indicating that communication for that radio access network node over one or more of the interfaces S₁, N₂ or N₃ is impacted. This might be an indication that the radio access network node is experiencing network performance degradation.

In another example, the network node 200 is configured to obtain information of a loss of connection between a CU and a DU, e.g., in terms of an indication that communication over the Fl interface is impacted. This might be an indication that one or more radio access network nodes is experiencing network performance degradation.

In another example, the network node 200 is configured to obtain information of a potential network performance degradation via a machine learning algorithm, where the used data set comprises at least the network KPIs, network measurements and/or measurement reports from terminal devices 120, 130, 140 served in the cellular network.

In another example, the network node 200 is configured to obtain information of a potential network performance degradation via public warning or emergency alerting information provided by an emergency center or PSAP. The information might relate to a potential emergency or disaster event and specify the predicted or actual time and location of the potential emergency or disaster event.

There could be different ways for the network node 200 to obtain the indication of increased need for network access. In some examples, the increased need for network access pertains to at least one of: detection of radio access network node failure caused by an emergency event, detection of increased number of emergency call attempts, a need of system information update to apply access barring for certain access classes, and/or a request from a public warning system or an emergency alerting system.

There could be different ways for the cell-shaping parameters to be adjusted.

According to some embodiments, the adjustment of the cell-shaping parameters pertains to adjustment of at least one of: antenna down-tilt, azimuth beam width, elevation beam width, azimuth beam direction, downlink transmit power, uplink transmit power configuration, and/or uplink frequency allocation for uplink transmissions. Thereby, the at least one radio access network node 110a:110d in the group of radio access network nodes 110a:110d for which adjustment of cell-shaping parameters is initiated will adjust its cell-shaping parameters accordingly. For example, depending on for which at least one radio access network node 110a:nod the cell-shaping parameters are to be adjusted, the at least one radio access network node 110a:110d might adapt its cell shapes to either better focusing on prioritized service and/or prioritized subscribers 120 in the affected region 150 (e.g., the MC communication service enabled terminal devices in a disaster/rescue area) or to offload traffic from the affected region 150.

Further examples of how the network node 200 might determine how the cell-shaping parameters should be adjusted to improve the performance for the prioritized service and/or prioritized subscribers 120 in the affected region 150 will now be disclosed.

In a first example, a radio access network node that provides network access to the affected region 150, but is running short of capacity and/or are functionally breaking down and therefore expected to within short no longer be capable of providing network access to the affected region 150 signals positions of subscribers of prioritized service and/or prioritized subscribers 120 to the network node 200. The network node 200 might then take this information into account when adjusting the cell-shaping parameters of radio access network nodes surrounding this radio access network node such that at least one neighboring radio access network node is instructed to provide network access where the subscribers of prioritized service and/or prioritized subscribers 120 are positioned within the affected region 150.

In one version of the first example, all radio access network nodes in the cellular network are constantly logging positions of subscribers of prioritized service and/or prioritized subscribers 120. Thus, if a disaster occurs and the functionality of one or more of the radio access network nodes is impacted, the network node 200 has access to information that can be used to adjust the cell-shaping parameters of at least one neighboring radio access network node to provide network access to subscribers of prioritized service and/or prioritized subscribers 120 are positioned within the affected region 150.

In another version of the first example, only those radio access network nodes that are located within prioritized regions regularly logs positions of subscribers of prioritized service and/or prioritized subscribers 120. This reduces the overhead compared to if all radio access network nodes always log positions of subscribers of prioritized service and/or prioritized subscribers 120. Thus, if a disaster occurs and the functionality of one or more of these radio access network nodes is impacted, the network node 200 has access to information that can be used to adjust the cell-shaping parameters of at least one neighboring radio access network node to provide network access to subscribers of prioritized service and/or prioritized subscribers 120 that are positioned within the affected region iso, if the affected region 150 is one of the prioritized regions.

In a second example, the message of a public warning or emergency alerting information comprises information of the area where high coverage/capacity is needed for subscribers of prioritized service and/or prioritized subscribers 120. The network node 200 might then use this information to adjust the cell-shaping parameters of one or more of the radio access network nodes.

In a third example, one of the radio access network nodes detects that there are many subscribers of prioritized service and/or prioritized subscribers 120 in a region affected by network performance degradation. The network node 200 might then use this information to adjust the cell-shaping parameters of one or more of the radio access network nodes.

In a fourth example, the cell-shaping parameters are determined by a machine learning algorithm.

Thus, in some aspects, at least one of the radio access network nodes 110a:110d logs the locations of subscribers using prioritized services or of prioritized subscribers 120. Hence, according to an embodiment, the network node 200 is configured to perform (optional) step S102:

S102: The network node 200 obtains positioning information, from the group of radio access network nodes 110a:110d, about positions of the prioritized subscribers 120 in the cellular network 100a:100e. The cell-shaping parameters might then be adjusted based on the positioning information.

As noted above, in order to limit the amount of data that is logged, only the locations of those subscribers that are within prioritized regions might be logged. That is, in some embodiments, the positioning information only is obtained from those radio access network nodes in the group of radio access network nodes 110a:110d that provide network access in prioritized regions.

In some aspects, the cell-shaping parameters are adjusted back to their original settings once there no longer is any need for the cell-shaping parameters as adjusted.

Thus, before this indication was obtained, the cell-shaping parameters had original settings, and the network node 200 is configured to perform (optional) steps S108, S110:

S108: The network node 200 obtains a further indication of either that the network performance degradation has ceased, or that the increased need for network access for prioritized service and/or prioritized subscribers 120 in the affected region 150 has ceased, or a combination thereof.

S110: The network node 200 initiates adjustment of the cell-shaping parameters back to their original settings.

For example, the network node 200 might initiate adjustment of the cell-shaping parameters back to their original settings when network performance degradation is recovered and/or when there has not been any need detected within a certain time period for prioritized service and/or prioritized subscribers 120 in the affected region 150. For example, a potential network node failure warning might be released when the network KPIs are back to normal performance, a previously disabled connection to the core network is re-established, the output from a machine learning algorithm indicates that the cellular network is back to normal situation, and/or when a further message of a public warning or emergency alerting information is received.

According to a first scenario, the first radio access network node 110a that provides network access in the affected region 150 remains undamaged. However, due to significantly increased network traffic demand (e.g., due to a comparatively large number of emergency calls being made), there is an increased need for network access for prioritized service and/or prioritized subscribers 120 in the affected region 150.

FIG. 4 illustrates a cellular network woe for such a scenario. FIG. 4 is similar to FIG. 2 but with the difference that the first radio access network node 110a has had its cell-shaping parameters adjusted such that its coverage region 160a′ is narrower compared to the coverage region 160a in FIG. 2 in order to improve network access in the affected region 150. As a consequence thereof, subscriber 140 might no longer be served by the first radio access network node 110a and neighboring radio access network node 110b therefore also has its cell-shaping parameters adjusted to provide network access for subscriber 140, as indicated by adjusted coverage region 160b′.

In some embodiments, adjustment of cell-shaping parameters is therefore initiated for the first radio access network node 110a. Cell shapes might thereby be adjusted to improve coverage or/and capacity within a disaster area and offload regular traffic in the disaster area to other radio access network nodes. For instance, the first radio access network node 110a located closest to the affected region 150 might be instructed to adjust its cell shape to focus on subscribers with prioritized services and/or prioritized subscribers 120, by narrowing its transmission/reception beams, or by redirecting its transmission/reception beams, to improve coverage and/or capacity in the affected region 150. Any of its neighboring radio access network nodes might be instructed to adjust their cell shapes to offload the regular network traffic from the affected region 150. That is, in some embodiments, adjustment of cell-shaping parameters further is initiated for at least one second radio access network node 110b in the group of radio access network nodes 110a:110e. This at least one second radio access network node iiob coverage-wise neighbors the first radio access network node noa. That two radio access network nodes coverage-wise neighbors each other here refers to that these two radio access network nodes have coverage regions that neighbor each other. As an example, in FIG. 2, radio access network node 100a neighbors both radio access network node iiob and radio access network node 110c since coverage region 160a neighbors both coverage region 160b and coverage region 16c; radio access network node 110b and radio access network node 110c also neighbors each other.

According to a second scenario, the first radio access network node 110a that provides network access in the affected region 150 is damaged or otherwise made inoperable. A temporary network, represented by at least one third radio access network node nod, might therefore be deployed to provide local communication for subscribers with prioritized services and/or prioritized subscribers 120 in the affected region 150 (but not for other subscribers).

FIG. 5 illustrates a cellular network mod for such a scenario. FIG. 5 is similar to FIG. 2 but with the difference that the first radio access network node 110a is damaged or otherwise made inoperable, as in FIG. 5 indicated by the first radio access network node 110a being crossed over. A temporary network, represented by a third radio access network node nod, is deployed with a coverage region 160d to provide network access in the affected region 150. The third radio access network node nod might not be enabled to provide network access in the whole coverage region of the first radio access network node noa. As a consequence thereof, subscriber 140 might not be served by the third radio access network node nod and neighboring radio access network node iiob therefore also has its cell-shaping parameters adjusted to provide network access for subscriber 140, as indicated by adjusted coverage region 160b′.

In some embodiments, adjustment of cell-shaping parameters is thus initiated for at least one third radio access network node nod in the group of radio access network nodes 110a:110d but not for the first radio access network node noa. The at least one third radio access network node nod is a radio access network node temporarily deployed in the affected region 150.

Any of the radio access network nodes neighboring the radio access network node that is damaged or otherwise made inoperable might be instructed to adjust their cell shapes to offload the regular network traffic from the affected region 150. Hence, in some embodiments, adjustment of cell-shaping parameters further is initiated for at least one second radio access network node 110b in the group of radio access network nodes 110a:nod. This at least one second radio access network node 110b coverage-wise neighbors the first radio access network node 110a.

According to a third scenario, the first radio access network node 110a that provides network access in the affected region 150 is damaged or otherwise made inoperable. According to this third scenario, deployment of a temporary network is not possible or not allowed. Hence, there is no ad-hoc deployed node to provide temporary network access for subscribers with prioritized services and/or prioritized subscribers 120 in the affected region 150.

FIG. 6 illustrates a cellular network woe for such a scenario. In FIG. 6 is similar to FIG. 2 but with the difference that the first radio access network node 110a is damaged or otherwise made inoperable, as in FIG. 6 indicated by the first radio access network node 110a being crossed over. As a consequence thereof, radio access network node 110b has its cell-shaping parameters adjusted, as indicated by adjusted coverage region 160b″, and radio access network node 110c has its cell-shaping parameters adjusted, as indicated by adjusted coverage region 160c′.

Any of the radio access network nodes neighboring the radio access network node 110a that is damaged or otherwise made inoperable might be instructed to adjust their cell shapes to provide network access for subscribers with prioritized services and/or prioritized subscribers 120 in the affected region 150. In some embodiments, adjustment of cell-shaping parameters is thus initiated for at least one second radio access network node 110b in the group of radio access network nodes 110a:110d but not for the first radio access network node noa. This at least one second radio access network node 110b coverage-wise neighbors the first radio access network node 110a.

The adjustment of cell-shaping parameters if performed by at least two of the radio access network nodes can be coordinated to avoid, or at least mitigate, inter-cell interference. For instance, given that the communication utilizes two or more frequency bands, during the network performance degradation, a first frequency band might be prioritized for providing network access to subscribers with prioritized services and/or prioritized subscribers 120 whereas network access to other subscribers is provided in a second frequency band. The cell shapes are adjusted according to any of the above disclosed embodiments. Hence, adjustment might be performed both spatially in terms of adjusted cell shapes and in frequency in terms of adjusted frequency bands or subscribers being moved among the frequency bands.

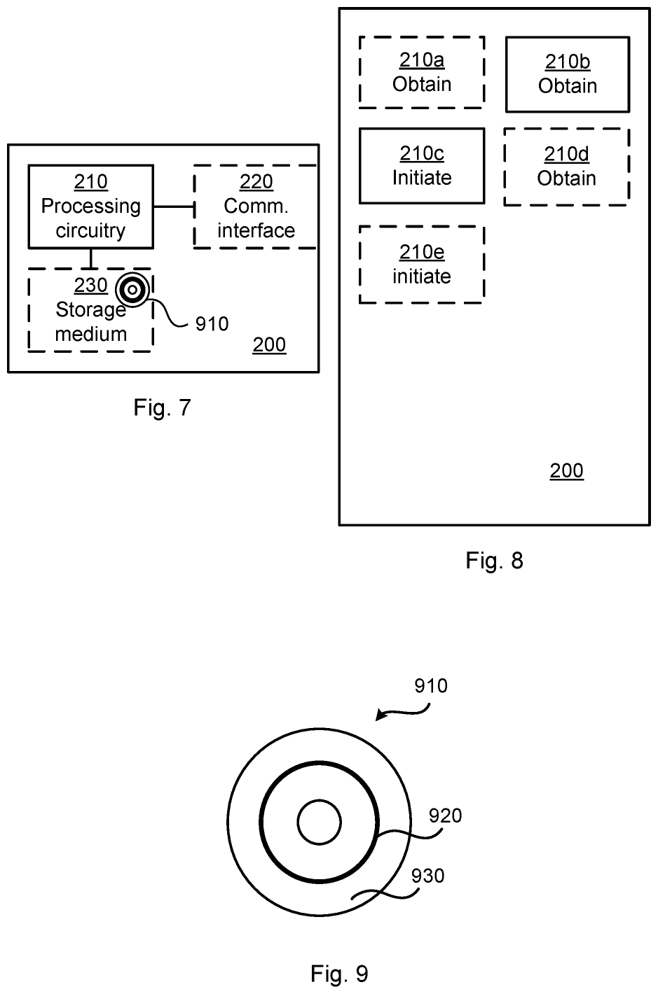

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, node, functions, and devices of the cellular networks 100a:100e. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; an obtain module 210b configured to perform step S104 and an initiate module 210C configured to perform step S106. The network node 200 of FIG. 8 may further comprise a number of optional functional modules, such as any of an obtain module 210a configured to perform step S102, an obtain module 210d configured to perform step S108, and an initiate module 210e configured to perform step S110.

In general terms, each functional module 210a-210e may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a-210e may be implemented by the processing circuitry 210, possibly in cooperation with the communications interface 220 and/or the storage medium 230. The processing circuitry 210 may thus be configured to from the storage medium 230 fetch instructions as provided by a functional module 210a-210e and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 the processing circuitry 210 may be distributed among a plurality of devices, or nodes. The same applies to the functional modules 210a-210e of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for adaptive cell-shaping in a cellular network in which a group of radio access network nodes provide network access, the method being performed by a network node, the method comprising:
obtaining an indication of combined network performance degradation in a region in which a first radio access network node in the group of radio access network nodes provides network access and increased need for network access for prioritized service and/or prioritized subscribers in the region; and
initiating adjustment of cell-shaping parameters of at least one radio access network node in the group of radio access network nodes, wherein network access for the prioritized service and/or prioritized subscribers in the region is maintained by said at least one radio access network node in the group of radio access network nodes.

2. The method of claim 1, wherein, before said indication was obtained, the cell-shaping parameters had original settings, and
the method further comprises:
obtaining a further indication of either that the network performance degradation has ceased, or that the increased need for network access for prioritized service and/or prioritized subscribers in the region has ceased, or a combination thereof; and
initiating adjustment of the cell-shaping parameters back to their original settings.

3. The method of claim 1, wherein
the prioritized service is a mission critical service, or a service as identified as prioritized by a network operator, and/or
the prioritized subscribers are identified as prioritized by belonging to a prioritized access class, by having a prioritized service profile identifier or are identified as prioritized by a network operator.

4. The method of claim 1, wherein adjustment of cell-shaping parameters is initiated for the first radio access network node.

5. The method of claim 4, wherein adjustment of cell-shaping parameters further is initiated for at least one second radio access network node in the group of radio access network nodes, wherein said at least one second radio access network node coverage-wise neighbors the first radio access network node.

6. The method of claim 1, wherein adjustment of cell-shaping parameters is initiated for at least one third radio access network node in the group of radio access network nodes but not for the first radio access network node, wherein the at least one third radio access network node is a radio access network node temporarily deployed in the region.

7. The method of claim 6, wherein adjustment of cell-shaping parameters further is initiated for at least one second radio access network node in the group of radio access network nodes, wherein said at least one second radio access network node coverage-wise neighbors the first radio access network node.

8. The method of claim 1, wherein adjustment of cell-shaping parameters is initiated for at least one second radio access network node in the group of radio access network nodes but not for the first radio access network node, wherein said at least one second radio access network node coverage-wise neighbors the first radio access network node.

9. The method of claim 1, further comprising:
obtaining positioning information, from the group of radio access network nodes, about positions of the prioritized subscribers in the cellular network, and wherein the cell-shaping parameters are adjusted based on the positioning information.

10. The method of claim 9, wherein the positioning information only is obtained from those radio access network nodes in the group of radio access network nodes that provide network access in prioritized regions.

11. The method of claim 1, wherein the indication of network performance degradation pertains to at least one of:
decreased network performance in terms of key performance indicators (KPIs) monitored in the cellular network,
network congestion experienced by the first radio access network node,
a loss of connection between the first radio access network node and its core network,
a loss of connection between a central unit (CU) in the first radio access network node and a distributed unit (DU) in the first radio access network node,
a loss of connection between a CU in the first radio access network node and a DU in another radio access network node in the group of radio access network nodes,
handover statistics indicating that no handovers have been made to, or from, the first radio access network node during a first predefined time period,
number of radio link failure reports issued during a second predefined time period being higher than a threshold number,
output from a machine learning algorithm,
a message of a public warning or emergency alerting information.

12. The method of claim 1, wherein the increased need for network access pertains to at least one of:
detection of radio access network node failure caused by an emergency event,
detection of increased number of emergency call attempts,
a need of system information update to apply access barring for certain access classes,
a request from a public warning system or an emergency alerting system.

13. The method of claim 1, wherein the adjustment of the cell-shaping parameters pertains to adjustment of at least one of: antenna down-tilt, azimuth beam width, elevation beam width, azimuth beam direction, downlink transmit power, uplink transmit power configuration, uplink frequency allocation for uplink transmissions.

14. A network node for adaptive cell-shaping in a cellular network in which a group of radio access network nodes provide network access, the network node comprising:
processing circuitry, the processing circuitry being configured to cause the network node to:
obtain an indication of combined network performance degradation in a region in which a first radio access network node in the group of radio access network nodes provides network access and increased need for network access for prioritized service and/or prioritized subscribers in the region; and
initiate adjustment of cell-shaping parameters of at least one radio access network node in the group of radio access network nodes, wherein network access for the prioritized service and/or prioritized subscribers in the region is maintained by said at least one radio access network node in the group of radio access network nodes.

15-16. (canceled)

17. A non-transitory computer readable medium storing a computer program for adaptive cell-shaping in a cellular network in which a group of radio access network nodes provide network access, the computer program comprising computer code which, when run on processing circuitry of a network node, causes the network node to:
obtain an indication of combined network performance degradation in a region in which a first radio access network node in the group of radio access network nodes provides network access and increased need for network access for prioritized service and/or prioritized subscribers in the region; and
initiate adjustment of cell-shaping parameters of at least one radio access network node in the group of radio access network nodes, wherein network access for the prioritized service and/or prioritized subscribers in the region is maintained by said at least one radio access network node in the group of radio access network nodes.

18. (canceled)

19. The network node of claim 14, wherein
before said indication was obtained, the cell-shaping parameters had original settings, and
the network node is further configured to initiate an adjustment of the cell-shaping parameters back to their original settings in response to obtaining a further indication of either that the network performance degradation has ceased, or that the increased need for network access for prioritized service and/or prioritized subscribers in the region has ceased, or a combination thereof.

20. The network node of claim 14, wherein adjustment of cell-shaping parameters is initiated for at a second radio access network node in the group of radio access network nodes but not for the first radio access network node, wherein the second radio access network node is a radio access network node temporarily deployed in the region.

21. The network node of claim 20, wherein adjustment of cell-shaping parameters further is initiated for a third radio access network node in the group of radio access network nodes, wherein said third radio access network node coverage-wise neighbors the first radio access network node.

22. The network node of claim 14, further comprising:
obtaining positioning information, from the group of radio access network nodes, about positions of the prioritized subscribers in the cellular network, and wherein the cell-shaping parameters are adjusted based on the positioning information.

23. The network node of claim 14, wherein the adjustment of the cell-shaping parameters pertains to adjustment of at least one of: antenna down-tilt, azimuth beam width, elevation beam width, azimuth beam direction, downlink transmit power, uplink transmit power configuration, uplink frequency allocation for uplink transmissions.
